(19) United States
(12) Patent Application Publication
(10) Pub. No.: US 2010/0041532 A1
(43) Pub. Date: Feb. 18, 2010

(54) SYSTEM OF ACTUATION OF DRIVE COUPLING TO ENGAGE AND DISENGAGE THE DRIVE TO ROTARY TOOL HOLDERS

(76) Inventor: Ashok Vishwanath Sathe, Bangalore (IN)

Correspondence Address: BIRCH STEWART KOLASCH & BIRCH, PO BOX 747, FALLS CHURCH, VA, 22040-0747, US

(21) Appl. No.: 12/522,330

(22) PCT Filed: Jan. 8, 2007
(86) PCT No.: PCT/IN07/00009

§ 371 Date: Jul. 7, 2009

(51) Int. Cl. B23B 29/32; B23Q 3/155

(52) U.S. Cl. 483/24; 483/56

(57) ABSTRACT

The present invention proposes a system of actuation of drive coupling to engage and disengage the drive to rotary tool holders in turrets, which are commonly used in turning centers, machining centers and lathes. The system of the present invention includes a driving means, a coupling means and an actuation means to enable smooth transmission of actuation force and modular design of the system. By using a standard off-the-shelf motor in conjunction with a cam, capable of delivering smooth movement to a linkage, the system allows for the engagement and disengagement of the coupling mechanism from the drive-end of the tools.

### BACKGROUND

1. Field of the Invention

This invention relates to a driving mechanism in turrets, which are used to mount and dismount tool holders within CNC Turning Centers, which perform multiple machining operations.

2. Discussion of Prior Art

Turrets are an integral component of CNC Turning Centers, which perform a variety of machining operations on a work piece such as drilling, milling, boring, etc. A multitude of tools are used for the various operations and these tools need to be mounted and dismounted from the tool holder, during the course of operation of the Turning Center. Mechanisms to support this engagement and disengagement of the tool holders reside within the turret.

Several mechanisms have been proposed for driving tool turrets in prior art.

EP 0 331 003 A2 describes a turret tool post particularly for lathes and machining centers, which uses drive-side and spindle-side coupling to mount the tool holders in a stepwise fashion. WO 03/084714 A1 proposes a driving system for rotary tools, which uses a couple of motor members during tool engagement/disengagement with a plurality of kinematic members for motion transmission. Further, a hydraulic system is used in this system for the purpose of actuation. EP 302998 discloses an apparatus wherein the tool holder has a drive shaft that is driven by a motor whose drive gear engages with the external gear teeth of a ring gear, which is mounted, in the turret head at a minimum distance from its front face. The TBMA series of tool holder turrets describes an apparatus, which has coupling of slots on the front face. This is driven by hydraulics and has no splines, on the front face. The MDT series of turrets discloses a coupling, which extends outside. Further, this uses components that adhere to DIN standards and is also driven by hydraulics. WO 03/009963 details an apparatus, which uses an electric motor in conjunction with bearings, to drive positioning of tools. Indian Patent No. 198051 describes and claims an Electrical Servo Turret consisting of an indexing drive or system, a face tooth/gear coupling and a clamping system consisting of a cam system to clamp and de-clamp the turret and an electric motor to drive the system.

A variety of methods are used to slide the coupling in and out of engagement. Typical systems use electrical solenoids, motors and hydraulic cylinders. Electrical solenoids have limited stroke and force. Besides this, the plunger movement is sudden, and uncontrolled. Designs using hydraulic cylinders require additional elements like power pack, hoses, valves etc. Thus the design requires costly additional elements, external to the turret rendering a high overall cost to the system. While the use of electrical solenoids and hydraulic motors are useful for mounting and dismounting tool holders, they come with the disadvantages of limited stroke and force (in the case of solenoids) and additional elements like power packs, hoses, valves etc. (in the case of hydraulic motors). The additional elements place limitations on the cost-effectiveness of the turret.

### SUMMARY OF THE INVENTION

Turrets are an integral component of turning centers, machining centers, lathes etc. They hold the tools that are required for the various stage of the machining operation. By separating the center into a turret and a driving component, modularity is maintained. Turrets are typically comprised of a tool holder. When the tool holder is rotary in nature, there exists a tool disc, which houses the tools along its circumference, each tool having its own holding area. The tool disc rotates about an axis, allowing the tools to be used in turn. In order to facilitate selective loading and unloading of tools, it is desirable to have a coupling mechanism, which holds the tools in place. This mechanism, upon an external command, is capable of engaging with the drive end of the tool, in order to lock the tool in place, so that the tool may be used. Once the tool has been put to use or another tool is required, this coupling mechanism disengages itself from the drive end of the tool while the tool disc rotates to bring the relevant tool into place. Then, the coupling mechanism again engages to the drive end of the tool so that it may transmit the actuating force needed for the to the tool to operate. The actuating force has to be delivered correctly in order to ensure precision of the machining operation. The actuating force in prior art has typically been provided with the use of hydraulic systems and solenoids, which come with their specific drawbacks.

The present invention overcomes the shortcomings of the previous proposals, by using a small electric motor and a gearbox to drive a cam, which in turn operates the sliding coupling through a linkage. The cam profile comes with the inherent advantage of a controlled, smooth movement of the coupling, with the ability to generate adequate actuating force at the coupling.

Further, the present invention provides a cost effective means for actuation of drive coupling to engage and disengage the drive to rotary tool holders. This is achieved by using a standard off-the-shelf motor, wherein the motor could be any of AC/DC Brush less or stepper motor.

### BRIEF DESCRIPTION OF DRAWINGS

FIG. 1 shows a typical outside view of these types of turrets.

FIG. 2 shows a top view of a turning center, incorporating the driven tool turret as a component.

FIGS. 3a and 3b show the details of a typical design of sliding coupling marked as ‘E’ in FIG. 2 with the sliding coupling disengaged and engaged respectively.

FIG. 4 shows a turret that uses an electrical solenoid to slide the coupling.

FIG. 5 shows a turret that uses an electric motor to slide the coupling.

### DETAILED DESCRIPTION OF PREFERRED EMBODIMENTS

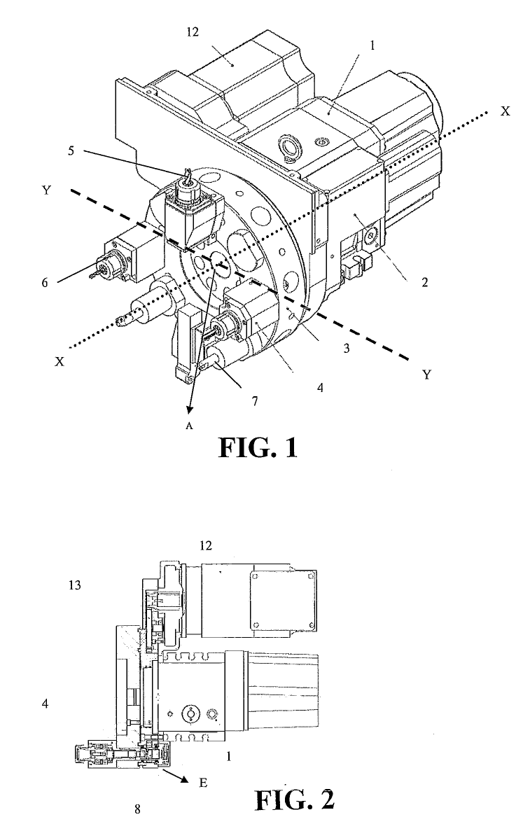

FIG. 1 describes a typical outside view of a turning center incorporating a view of the tool turret. The tool turret 1 is one module, 2 describes the coupling actuating mechanism, 3 describes the tool disc with a rotary tool holder 4 having number of tools mounted on it. These tools 5, 6 and 7 are capable of performing the desired actions while the actuating mechanism 2 is used to operate the sliding coupling through a linkage. There is a drive motor 12, which is used to provide tangential motion to the tool disk 3, causing it to rotate. The drive motor and the tool turret are stationary while the tools 5, 6, 7 are moved in and out of place, to perform the desired action, at the desired time.

FIG. 2 describes the top view of the turning center whose modules include a drive motor for rotary tools 12, a turret 1, a drive train 13 and a component E, comprising the rotary tool holder 4 and a sliding coupling 8. The drive train 13 delivers tangential movement to the rotary tool holder 4. In a turning center, several tools (5, 6, 7 from FIG. 1) are used to perform a variety of operations. Since these tools are used one at a time, they have to be rotated and placed properly, in order to be used. The rotary tool holder makes provisions for moving each of the tools into place, when they are required.

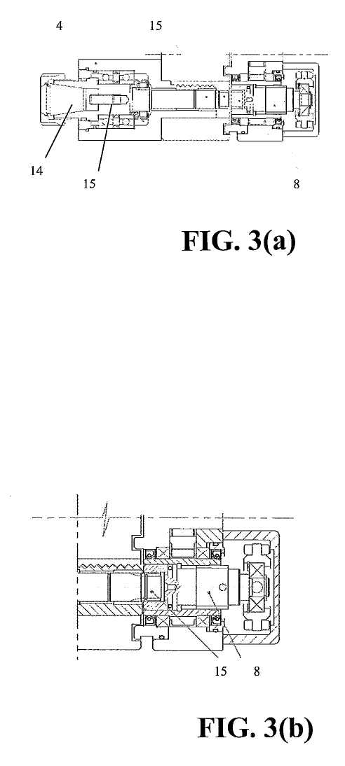

FIG. 3a shows a detailed view of the component marked E in FIG. 2. Further, this elaborates the section marked X-X, in FIG. 1. At the front is the machining tool 14 while projects into the rotary tool holder 4. The tool is encased in a cavity 15, which is part of the rotary tool holder. The tool has two ends, the end at the rotary tool holder 4 and the drive end 15, which is powered in order to facilitate its motion. When no tool is in use or a different tool is required, the sliding coupling 8 is dis-engaged, as shown in FIG. 3a. This effectively removes contact between the combination of the driving mechanism (the electric motor) along with the cam 8 (referred to as the sliding coupling) and the drive end of the tool 15.

During use, the sliding coupling 8 has to be engaged, which locks the tool into place in the rotary tool holder 4. FIG. 3b shows the same arrangement of the apparatus with the sliding coupling in the engaged position wherein contact is resurrected between the sliding coupling 8 and the drive end of the tool 15.

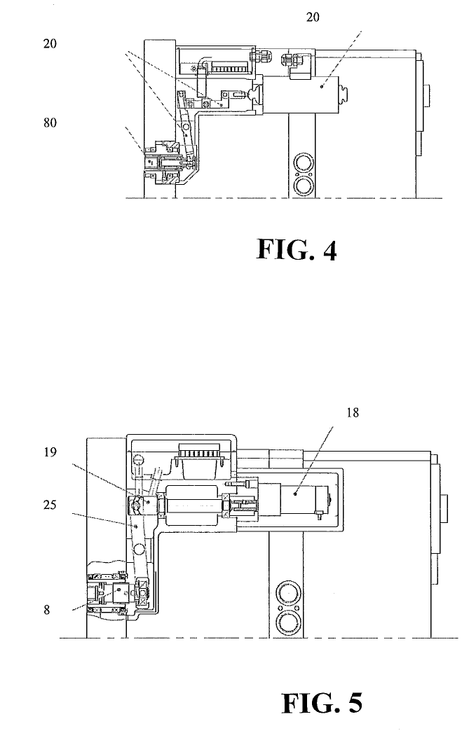

FIG. 4 shows a turret that uses an electrical solenoid 20 and a plunger mechanism, which serves as a linkage 21, to engage and dis-engage the sliding coupling 80. This is with reference to the apparatus of the prior art. In this case, the plunger movement is sudden and un-controlled. Further, the solenoid 20 has limited stroke and force. These limiters make this setup undesirable.

FIG. 5 shows a turret of the present invention, which uses an electric motor to slide the coupling. This arrangement is comprised of an electric motor with a gear box 18, which operates in conjunction with the CAM 19 and powers the slide coupling mechanism 8 by means of a linkage 25. As compared to prior art, the present invention uses a set of gears in conjunction with a motor which can be an off the shelf component and low cost alternative. This motor is used to engage and disengage the sliding coupling mechanism. The tools in this case are engaged or disengaged selectively one after another. The component of the CAM driven by the motor moving the linkage mechanism described in the present invention makes room for a modular design which uses commonly available motor. The CAM is described in the present invention allows for control and smooth movement of the coupling while generating adequate actuating force of the coupling. The electric motor used can be any of AC/DC Brush less or stepper motor.

1. A system for actuating the drive system of a tool turret for turning centers, machining centers, lathes and the like, which typically have a stationary drive motor, a tool turret comprised of a tool disc having plurality of tool housings distributed around the circumference of the disc, each of the said housings being equipped with a respective spindle for holding a rotary tool comprising a drive end arranged parallel to said rotational axis A and a rotary tool holder with a cavity which extends around a longitudinal axis A, where the tool disc has a rotational axis X-X which co-incides with the longitudinal axis A, a coupling mechanism along axis X-X of the turret and an actuating mechanism along axis Y-Y of the turret including:
a. Driving Means to drive the rotary tool holder by supplying it with tangential impetus, which causes the tool disc to rotate about the axis A;
b. Coupling Means to transfer electric power from an electric motor, through a cam to a linkage, which engages and disengages the drive end of individual tools in the rotary tool holder; and
c. Actuating Means to provide a driving force, which sets the coupling, means in motion.

2. A system of claim 1 wherein the driving means is comprised of a drive motor, which provides tangential impetus to the tool disc of the turret, causing it to rotate about the axis of rotation A, allowing for tools to be used, one at a time, upon an external command, where the force is communicated by means of a set of gears placed between the drive motor and the turret.

3. A system of claim 1 wherein the coupling means is comprised of a cam and a linkage, said cam being operated by a set of gears in a gear box attached to the electric motor placed adjacent to it, said cam being capable of delivering controlled motion to the linkage, which acts as a lever, one end of which is attached to the cam, the other end being attached to the driving end of the tool, said coupling means having:
a. An engaged position wherein the linkage is attached to the driving end 15 of the tool, delivering the requisite electric power to the tool while locking the tool in place; and
b. A dis-engaged position wherein the linkage is disjointed from the driving end 15 of the tool, to allow the use of a different tool or when the use of the tool has been completed.

4. A system of claim 3 wherein the linkage delivers electric power to the drive end of the tool, allowing for a sliding motion of the drive end of the tool to allow an engaged and dis-engaged configuration of the coupling mechanism.

5. A system of claim 1 wherein the actuating means is comprised of an electric motor and the gearbox that allows the cam to move the linkage between the desired engaged and disengaged positions.

6. A system of claim 5 wherein the motor could be any of AC/DC, brush less or stepper motor.
